(19) United States
(12) Patent Application Publication
(10) Pub. No.: US 2006/0157036 A1
(43) Pub. Date: Jul. 20, 2006

(54) Positive displacement supercharging apparatus for use in an in-line internal combustion engine and its method of formation

(75) Inventor: Stephen M. Andersen, Elkton, MD (US)

Correspondence Address: James R. Derry;JRD Investment Company, Suite 100, 10647 Grimsby Lane, Cincinnati, OH, 45241, US

(73) Assignee: EKM Engineering, Inc.

(21) Appl. No.: 11/331,607

(22) Filed: Jan. 14, 2006

Related U.S. Application Data
(60) Provisional application No. 60/644,764, filed on Jan. 18, 2005.

(51) Int. Cl. F02B 33/00

(52) U.S. Cl. 123/563; 123/559.1

(57) ABSTRACT

A positive displacement supercharger apparatus and its method of formation are provided for use in an inline cylinder engine. The positive displacement supercharger is structurally supported by a non-OEM intake manifold. The non-OEM intake manifold provides efficient structural support, direct and efficient air flow path, and implementation flexibility. The non-OEM intake manifold further comprises an optional air charge cooling device, plenum volume and inlet runners that are integrally connected to form the non-OEM intake manifold. The disclosed positive displacement supercharger apparatus is configured to receive air flow from the rear of the device through appropriate ducting on the intake side of the inline engine.

### CROSS-REFERENCE TO RELATED APPLICATION

This non-provisional U.S. patent application claims the benefit of provisional U.S. patent application Ser. No. 60/644,764, filed on Jan. 18, 2005, which is hereby incorporated by reference in its entirety.

### FIELD OF THE INVENTION

The invention generally relates to a supercharger apparatus configured to work with internal combustion engines and its method of formation. More particularly, the invention relates to a positive displacement supercharger apparatus for use in an in-line internal combustion engine, and a method of forming the same. The present invention can be used with any in-line engine configuration including but not limited to automotive, diesel and marine engines.

### BACKGROUND OF THE INVENTION

There are many factors that characterize the torque output of any given internal combustion engine. For example, the swept volume within cylinders, the cylinder configuration, the bore-to-stroke ratio, the compression ratio, the connecting rod length to stroke ratio, the valve train arrangement, and the inlet and outlet (exhaust) arrangement.

Engine developers are constantly tuning engines by adjusting these parameters and others in the search for increased fuel economy and performance. However, this does not necessarily result in increased power or torque. Engine torque is typically perceived as being one of the most important factors to an average driver's perception of performance. In particular, engine torque delivered at lower engine speeds (low rpm's), e.g., below 3500 rpm's for a typical automobile application, is desired among automotive drivers.

For this reason, an engine can be tuned to give higher torque at lower rpm's, e.g., below 3500 rpm's. This will typically, however, result in a loss of torque at higher engine speeds, e.g., above 3500 rpm's. The same engine could be ‘re-tuned’ to deliver the same torque but at much higher crankshaft rotation speeds. This results in significantly higher peak power but at the expense of a loss of torque at the lower rpm's, and reduces the acceleration performance at the lower engine speeds. For example, most automobiles are driven below 3500 rpm's for the majority of their useful lives under normal daily driving conditions.

To address this concern, engine designers have employed different techniques and technologies to overcome this traditional compromise. For example, variable geometric intake systems, variable camshaft timing and variable valve lift and timing. All of these approaches, among others, are designed to maintain more than one ‘state of tune’ depending on the desired operating conditions of the automobile.

In the past few years, a more commonly used technique is to reject engine tuning, as described above, as a method for increased performance. Lately, a majority of these automobiles now employ a turbo-charger or centrifugal supercharger. Such forced induction generally results in significant increases in torque and power.

A centrifugal supercharger, similar to a turbo-charger, increases the amount of air being injected into the cylinders of the internal combustion engine. Along with the increased air, increased fuel consumption can occur with the increased amounts of air present in the cylinders. The resulting effect is the same internal combustion engine for the automobile produces a higher output than it was designed to do without the charging of the air prior to the injection of the fuel and air into the cylinders of the internal combustion engine.

A supercharger utilizes the power generated by the internal combustion engine to power a blower, typically through the use of a pump or compressor, to force more air into the internal combustion engine. Conversely, a turbo-charger receives its power from the stream of exhaust fumes exiting the automobile through the exhaust manifold. Regardless of where the force inducted units obtain their power to charge the air coming into the internal combustion engine, both force induction units enhance performance by increasing the amount of air entering the internal combustion engine for combustion of fuel.

Although the performance of turbo-chargers is acceptable, there are problems associated with their use including: a) the space they occupy in the engine compartment; b) the heat radiated from the turbine section within the engine compartment; and, c) the high-level of maintenance required to maintain this particular type of forced induction. Further, there is a time lag associated in the responsiveness of the turbo-charger. This is particularly evident at lower speeds. For instance, no appreciable power gains are achieved at the lower rpm's; but, only at the higher rpm's, i.e., above 3500 rpm's. Similarly, there are problems associated with adding a centrifugal supercharger to an internal combustion engine of an automobile.

One problem with adding a centrifugal supercharger is the increased size of the resulting internal combustion engine. A centrifugal supercharger typically is mounted on a front or top surface of the internal combustion engine. The centrifugal supercharger is mounted in this manner due to the proximity of the source of drive power to the centrifugal supercharger from the accessory drive pulley and belt system which is typically located near the front of the automobile.

By adding a centrifugal supercharger in one of the above-referenced locations, typically while maintaining the use of an OEM intake manifold, the overall profile of the internal combustion engine grows. This increases the manufacturing costs associated with doing such forced induction modifications to the internal combustion engine, e.g., a larger hood and relocation of internal components for the engine is required. In other applications, such as in a turbo-charged system, significant compromises in the engineering of the system must be accepted, often resulting in convoluted air flow paths and ducting, or reduced ducting cross sections which negatively impact performance and efficiency of the system. This is an increasingly difficult problem with modern automobiles, which are increasingly crowded under the hood with additional electronics and luxury features.

Automotive superchargers can be categorized into two categories: positive displacement and centrifugal. Centrifugal superchargers, in essence, act in a similar fashion to the compressor side of a turbo-charger. The centrifugal supercharger is driven by a belt from the engine's crankshaft through an overdrive device, i.e., a second belt drive or gears. Air flows continually and is dynamically compressed inside the housing, giving centrifugal superchargers high efficiency. Dynamic characteristics and other particulars, however, remain a problem associated with the use of a centrifugal supercharger. In dynamic terms, the mass flow rate of a centrifugal supercharger is roughly proportional to the square of the compressor's rotational speed.

In other words, boost (psi) rises non-linearly with climbing rpm's, and air flow, and hence power is biased strongly toward the top end (at rpm's significantly above 4000). Centrifugal superchargers have proven especially popular with domestic car owners, whose automobiles typically have large displacement engines (greater than 4.6 L) with healthy low speed torque, but need a boost at high rpm's. As such, a wide variety of compact applications have found their way to market, i.e., Paxton and Vortech.

A positive displacement supercharger, in contrast to a centrifugal supercharger, fills a chamber of a fixed volume with air at atmospheric pressure, and moves that air to a high pressure side. Positive displacement superchargers give a flat torque curve throughout the engine's operating range (entire RPM band) and good throttle response (no lag) in contrast to a turbo-charger or centrifugal supercharger.

Perhaps the oldest positive displacement supercharger is the Roots-type supercharger. One modern Roots-type of supercharger is manufactured by a company called Eaton. Another positive displacement supercharger, which is not a Roots-type supercharger, is the Lysholm, or twin-screw supercharger, e.g., a Whipple or Autorotor twin-screw supercharger. The twin-screw supercharger moves fixed amounts of air per revolution, similar to the Roots-type supercharger. Unlike the Roots-type supercharger, however, which is only an air delivery system, the twin-screw supercharger is also a compressor. Compressed air is delivered into the compression environment of the intake manifold with little leakage or loss of energy. The Whipple twin-screw supercharger, for instance, has an adiabatic efficiency of 65%-80% across the whole power band. In contrast, a typical Roots-style supercharger has an adiabatic efficiency of 35-55% across the whole power band.

Typically, the Lysholm twin-screw supercharger is suited for high-boost operations, i.e., greater than 14.7 psi, and the Eaton supercharger is suited for low-boost operations, i.e., lower than 14.7 psi. For example, non-AMG Mercedes-Benz automobiles typically use an Eaton supercharger, whereas higher performance automobiles such as the AMG Mercedes models use a twin-screw supercharger. It should also be noted that the AMG Mercedes models employ a V-shaped engine configuration rather than an in-line engine configuration.

The twin-screw supercharger creates positive intake manifold pressure (boost) the instant the throttle is touched, and generally reaches almost maximum boost by 2000 engine rpm's, which is available throughout the entire power band. The twin-screw supercharger is relatively quiet, with only a low level of detectable gear noise, producing little discernible sound compared to a turbo-charger, Roots-type supercharger, or centrifugal supercharger. For example, the Roots-type supercharger is inherently noisy, largely from the pulsing of the air delivery into the engine, and the fact that the gearing required to run the rotors of the Roots-type supercharger requires more power from the crankshaft due to its reduced adiabatic efficiency.

The main drawback of positive displacement superchargers (Roots-type) is that air flow comes in bursts, rather than smoothly and continuously as with a centrifugal supercharger compressor. Another problem is that positive displacement Roots-type superchargers compress the air simply by shoving it into the intake manifold. As a chamber of not-yet-pressurized air is opened to an intake manifold of already-pressurized air, air first rushes from the intake manifold into the chamber, before being shoved back out into the intake manifold. Thus, much of the air is pumped twice, and it goes past the edges of the Roots-type supercharger exit three times. The resulting turbulence heats the air, reducing efficiency.

Manufacturers of engines are always seeking to increase the power output of their engines while maintaining reliability and fuel efficiency. One way of doing this is by reducing the weight of the engine. Another important characteristic is the ease of maintenance of such engines, which is partly dependent upon the ease of access to the internal components of the engine. A final important aspect involves reducing the cost of manufacture. The present invention addresses these concerns by providing a novel positive displacement supercharger apparatus for use in an in-line internal combustion engine, and its method of formation.

### BRIEF SUMMARY OF THE INVENTION

In general, the present invention, in various exemplary embodiments, provides a fabrication method and a positive displacement supercharger apparatus used for internal combustion engines with an in-line cylinder configuration.

In one exemplary embodiment, a positive displacement supercharger apparatus is provided for use in an inline cylinder engine. The positive displacement supercharger is securely mounted to a non-OEM intake manifold that is engineered as a component of the positive displacement supercharging apparatus. The non-OEM intake manifold provides efficient structural support, direct and efficient air flow path, and implementation flexibility. The non-OEM intake manifold is configured to work with the in-line cylinder engine and positive displacement supercharger.

In another embodiment, a twin-screw supercharger apparatus is provided for use in an inline cylinder engine. The twin-screw supercharger is structurally supported by a non-OEM intake manifold. The non-OEM intake manifold further comprises a plenum volume and inlet runners integrally formed as part of the non-OEM intake manifold.

In still another embodiment, a positive displacement supercharger apparatus is provided for use in an inline six cylinder engine. The positive displacement supercharger is securely mounted to a non-OEM intake manifold that is engineered as a component of the positive displacement supercharging apparatus.

In still yet another embodiment, a twin-screw supercharger apparatus is provided for use in an inline cylinder engine. The twin-screw supercharger is structurally supported by a non-OEM intake manifold. The non-OEM intake manifold further comprises a plenum volume, an air charge cooling device and inlet runners integrally formed within the non-OEM intake manifold.

According to other embodiments of the invention, methods of forming the various embodiments of the positive displacement supercharger apparatus are provided for use in an inline cylinder engine. The positive displacement supercharger apparatus is designed to have the air flow enter the rear of the positive displacement supercharging device comprising a non-OEM intake constructed manifold that provides at least in part, structural support for the positive displacement supercharging device.

### BRIEF DESCRIPTION OF THE DRAWINGS

The above and other advantages and features of the invention will be more clearly understood from the following detailed description which is provided in connection with the accompanying drawings.

FIG. 1 is a perspective view of one exemplary embodiment of the positive displacement supercharger apparatus.

FIG. 2 is a top view of the exemplary embodiment illustrated in FIG. 1 of the positive displacement supercharger apparatus.

FIG. 3 is a front view of the exemplary embodiment illustrated in FIGS. 1-2 of the positive displacement supercharger apparatus.

FIG. 4 is an exploded view of an embodiment of the positive displacement supercharger apparatus comprising a charge air cooler.

FIG. 5A is a schematic of the airflow path into an in-line internal combustion engine employing a positive displacement supercharger apparatus illustrated in FIGS. 1-4 and the direction and the relative location of the internal combustion engine to the positive displacement supercharger apparatus.

FIG. 5B is another top view of the exemplary embodiment illustrated in FIG. 1 of the positive displacement supercharger apparatus indicating the primary airflow.

FIG. 6 is a rear and side view of the positive displacement supercharging device illustrating the rear inlet and outlet of the device facing toward the passenger side of the automobile with an internal combustion engine that is longitudinally-mounted in a typical automobile.

FIG. 7 is a partial view illustrating two different positive displacement supercharging devices with differently positioned air inlets.

FIG. 8 is a detailed view of the intake manifold of the positive displacement supercharging apparatus that can be used in one embodiment of the present invention.

### DRAWINGS—REFERENCE NUMERALS AND IDENTIFICATIONS

2—Air Inlet and filtration device
4—Air ducting
6—Airflow or air mass measurement device
8—Air ducting
10—Optional Throttling valve (throttle valve)
12—Air ducting
14—Air housing or inlet
16—Positive displacement supercharging device
18—Pulley or other pump/compressor drive device
20—Optional charge air cooling device
22—Optional liquid manifolds
24—Optional liquid pump and lines
26—Optional Heat exchanger
28—Intake manifold
30—Individual cylinder distribution means of intake manifold or inlet runners
32—Optional Boss/attachment for positive displacement supercharging apparatus structural support and intake manifold support
34—Optional location for additional individual throttle valves
36—Air bypass valve
38—Supplemental positive displacement supercharging apparatus structural support
40—Supplemental positive displacement supercharging apparatus structural support and intake manifold support
42—Internal combustion inline engine cylinder head
70—Air Inlet on Positive Displacement Supercharging Device
71—Air Outlet on Positive Displacement Supercharging Device
80—Plenum volume of the intake manifold
99—Positive Displacement Supercharging Apparatus

### DETAILED DESCRIPTION OF THE INVENTION

In the following detailed description, reference is made to the accompanying drawings which form a part hereof and illustrate specific exemplary embodiments by which the invention may be practiced. It should be understood that like reference numerals represent like elements throughout the drawings. These embodiments are described in sufficient detail to enable those skilled in the art to practice the invention. It is to be understood that other embodiments may be utilized, and that structural, logical and electrical changes may be made without departing from the spirit and scope of the present invention.

The term “internal combustion engine” is to be understood as a heat engine in which combustion occurs in a confined space called a combustion chamber. Combustion of a fuel creates high temperature/pressure gases, which are permitted to expand. The expanding gases are used to directly move a piston, turbine blades, rotor(s), or the engine itself. If the expanding gases are used to turn turbine blades, as in a gas turbine/jet engine, one skilled in the art would know that the fuel/air mixture is burned in a separate combustion chamber. All internal combustion engines depend on the exothermic chemical process of combustion: the reaction of a fuel, typically with air. For instance, some non-limiting examples of fuel are gasoline, hydrogen, or the use of an electric motor in combination with gasoline or hydrogen. An internal combustion engine can be used in an automobile, RV, trucks, tractor trailers, diesel automobiles and marine applications.

The term “in-line” or “inline” is to be understood as an inline engine in which the cylinders are aligned in a single row.

Moreover, when reference is made to an “OEM” part, it is a part that is provided by, made by, or manufactured by the original manufacturer of the in-line internal combustion engine. In general, an OEM part is one that comes as manufactured or supplied by the original manufacturer to a consumer.

When reference is made to a “non-OEM” part, it is a part that is not provided by, made by, or manufactured by the original manufacturer of the in-line internal combustion engine. In general, a non-OEM part is one that does not come as manufactured or supplied by the original manufacturer to a consumer.

When reference is made to a “positive displacement supercharging apparatus”, it should be understood that the apparatus comprises a plurality of parts including but not limited to a positive displacement supercharging device.

Finally, when reference is made to an “intake manifold”, it should be understood that an intake manifold can also known be known as an air inlet manifold and inlet air manifold for purposes of describing the present invention. In addition, for purposes of the present invention, the intake manifold comprises a plurality of parts that may include the plenum volume, the distribution means/runners, the charge air cooler, or any combinations thereof.

Although the invention is described herein with reference to the architecture and fabrication of a positive displacement supercharger apparatus used in an in-line internal automotive combustion engine, it should be understood that the invention has applicability to other in-line internal combustion engines using a positive displacement supercharger apparatus. The following detailed description is, therefore, not to be taken in a limiting sense, and the scope of the present invention is defined only by the appended claims.

In general, there are three different engine configurations commonly used in automobiles. Inline: the cylinders are arranged in a line in a single bank. V-shaped: the cylinders are arranged in two banks set at an angle to one another. Finally, flat (also known as horizontally opposed or a boxer): the cylinders are arranged in two banks on opposite sides of the engine. The present invention has particular utility with an inline engine.

An inline engine is long and narrow. In small cars, such as the Honda civic, or similar front wheel drive vehicle, a long and narrow engine mounted transversely can allow a very short hood. In other cars, such as a BMW 3-series, the long and narrow engine allows specific placement, inside the engine compartment of the automobile, such that a near perfect 50/50 (front/rear) weight distribution can be attained. The inline engine needs only half as many camshafts as a V-shaped configuration (if using overhead cams), which can reduce weight, complexity and frictional losses in the engine. Typically, an inline engine is heavier than a V-shaped engine.

The present invention finds particular utility in an inline engine with six cylinders. The straight-6, i.e., an inline 6, I-6, I6, or L6 is an internal combustion engine with six cylinders aligned in a single row. I-6 engines have perfect primary and secondary balance and require no balance shaft. I-6 engines typically have an engine displacement of approximately 2.5 L to approximately 4.0 L. Many automotive manufacturers build automobiles equipped with straight six engines, i.e., BMW, Volvo, Toyota and Lexus.

As discussed in the Background, superchargers achieve performance gains by increasing the density of the air/fuel charge within the combustion chambers of an engine. This increase in density is achieved by forcing and/or compressing additional amounts of air (beyond the amount of air that normal atmospheric pressure would force into the engine) at the lowest temperature possible. CFM (cubic feet per minute) is used to indicate the volume of air that an engine is flowing, while MAF (mass air flow) factors in the density of the air charge. A cooler and dryer air charge is denser, and therefore, provides the potential for extracting more power from the internal combustion engine. In other words, supercharging increases both the volumetric efficiency of the internal combustion engine and the mass air flow to produce gains in both horsepower and torque.

A typical automobile four cycle engine's operation is complex but can be reduced to basic fundamentals. Air and fuel are drawn into an internal combustion engine through an OEM fuel-mixing device or OEM throttle valve and an OEM intake manifold (the intake stroke); the fuel and air is compressed inside a chamber by the upward travel of an OEM piston (the compression stroke), after which the compressed mixture is ignited by the spark of a spark plug, and the heat and expansion of the combustion gases pushes the OEM piston downward, which in turn, forcefully rotates the OEM crankshaft (the ignition/power stroke). Then the spent exhaust gases are routed out through the exhaust valve (the exhaust stroke) on the upward stroke of the OEM piston. This is essentially how an OEM engine operates.

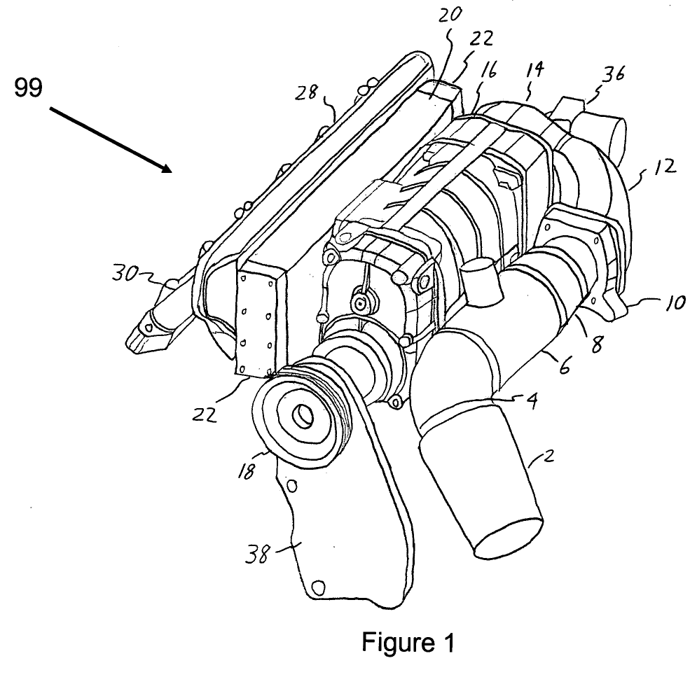

Previously, many tuners have attempted to configure a centrifugal supercharger with an inline internal combustion engine. These attempts have been somewhat successful. Tuners have also used turbo-chargers with an inline internal combustion engine with some success as well. Although twin-screw superchargers have been used in other vehicles that do not have an Inline configuration, many attempts at configuring a twin-screw or positive displacement supercharger with an inline internal combustion engine have been unsuccessful. Specifically, many attempts at creating a positive displacement supercharger package that will work with from approximately 2.5 L to approximately 4.0 L I-6 internal combustion engines have met with failure. The present invention successfully configures a positive displacement supercharger apparatus with an inline internal combustion engine. As such, a description of the present invention and methods of formation will now be described in more detail referring to FIGS. 1-8.

Referring to FIGS. 1-4, which illustrate one exemplary embodiment, a positive displacement supercharging apparatus (99) is provided. The positive displacement supercharging apparatus (99) comprises an air inlet and filtration device (2), i.e., an air intake apparatus. This air intake apparatus (2) is preferably located in the stock vehicle location, or a location which provides adequate inlet air supply for the inline internal combustion engine. For purposes of a simplified description, the inline internal combustion engine is not illustrated in the figures.

The stock vehicle location is the location where the OEM air intake apparatus (2) is located as provided by the original manufacturer. Alternatively, a non-OEM part (not illustrated) can be provided as the air intake apparatus (2), if desired. For instance, a non-OEM intake apparatus can be provided which is designed to increase inlet airflow, or provide heat-shielding of the air inlet to insure adequate supply of air which is not affected by heat generated by the internal combustion engine. The non-OEM intake apparatus can be provided in the stock location where the original OEM air intake apparatus (2) is located, or, can be provided in a non-stock location.

Still referring to FIGS. 1-4, air can then flow through an air duct (4). The location of the air intake apparatus (2) will, at least in part, determine the length of air duct (4). The diameter of air duct (4) should be sufficient to meet the air flow requirements of the internal combustion engine. The length of air duct (4) can typically range from approximately 2″ to approximately 18″, and has a common internal diameter of from approximately 2.5″ to approximately 4″. The air duct (4) may comprise a material such as steel, aluminum, or other tubing that comprises a metal or metal alloy, or alternatively, may be constructed of non-metallic materials such as plastics, composites or other materials suitable for air ducting in an inline internal combustion engine.

The air will then flow through this air duct (4) to an airflow or air mass measurement device (6). This air flow measurement device (6) can be an OEM part provided with the automobile by the manufacturer. Alternatively, the air flow measurement device (6) can be a non-OEM part (not illustrated), which can be designed to reduce air flow resistance, or increase the effective air flow measurement range outside of the stock OEM air flow measurement range. For instance, if the OEM air flow measurement device (6) has a maximum measurement capability of 400 CFM's, a non-OEM air flow measurement device can have maximum measurement capability from approximately 300 to approximately 1300 CFM's.

Some automobiles, however, do not utilize an air flow measurement device as part of the engine management system. In these cases, a carburetor can be used, or in the case of alternate engine and fuel management systems (such as a stand-alone engine management system), Manifold Absolute Pressure (MAP) sensors, or alpha-N (throttle angle v. engine rpm is used to estimate the airflow of the inline internal combustion engine based on known volumetric efficiency parameters.

Airflow then progresses through air ducting (8), which will typically range from approximately 2″ to approximately 12″ in length and from approximately 2.5″ to approximately 4″ in diameter. The air then flows typically through a throttling valve (10), or similar OEM parts that control the inline internal combustion engine's power output. The air ducting (8) may comprise a plurality of connections for pre-throttle air supply for an idle air bypass system, positive crankcase ventilation system, or other analogous structures.

Again, in some certain engine configurations or advanced engine control methods, a throttle valve (10) may not be present or required. In the situations where a throttle valve (10) is not present or not required, one can either be added as a non-OEM part, or an additional non-OEM structure can be utilized to assist in reducing the sound produced by the positive displacement supercharger apparatus (99).

Recent developments in engine management and controls have resulted in OEM application of engines that use direct control of the automotive valve train, or other similar methods to control engine output in place of the commonly used throttle valve (10). In the application of a positive displacement supercharger apparatus (99), the throttle valve (10) assists in reducing the noise emitted from the positive displacement supercharging device (16) under part-throttle conditions. The removal of the throttle valve (10) may, in some cases, result in unacceptable noise emissions from the positive displacement supercharging device (16). In these cases, it may be necessary to add a silencing apparatus (not illustrated) to the inlet of the positive displacement supercharging device (16). A silencing apparatus is well-known in the art and is neither discussed nor illustrated for the sake of brevity.

Still referring to FIGS. 1-4, airflow then progresses through air ducting (12), which may range from approximately 2″ to approximately 12″ in length and from approximately 2.5″ to approximately 4″ in diameter, and enters a housing or inlet (14). This housing or inlet (14) serves to turn and direct the air into the back or rear of the positive displacement supercharging device (16) with minimal turbulence and losses.

It is important in the design of this housing or inlet (14) that attention be paid to maintaining or increasing the cross-sectional area of the air ducting (12) up to the point of intersection with the positive displacement supercharging device (16), and that all turns or changes in direction of the airflow be as gradual as possible given the packaging constraints of the automobile. In other words, the ducting provided in an automobile should comprise angles less than 90° where possible. In more particular terms, the housing or inlet (14) serves to substantially reduce air turbulence prior to airflow that enters the positive displacement supercharging device (16).

Air flows through this housing or inlet (14) to an inline engine driven pump or compressor located within the positive displacement supercharging device (16). The positive displacement device (16), in one embodiment, is a twin-screw supercharging device (16). The positive displacement supercharging device (16) pressurizes the airflow into the inline internal combustion engine for the purpose of increasing engine power output, efficiency and performance. The air ducting (12) or housing or inlet (14) may comprise a plurality of additional connections for plumbing of various structures to provide a supply of engine vacuum. These structures may include (but are not limited to) the vacuum brake booster, positive crankcase ventilation valve, idle air bypass outlet, and evaporative emissions connections.

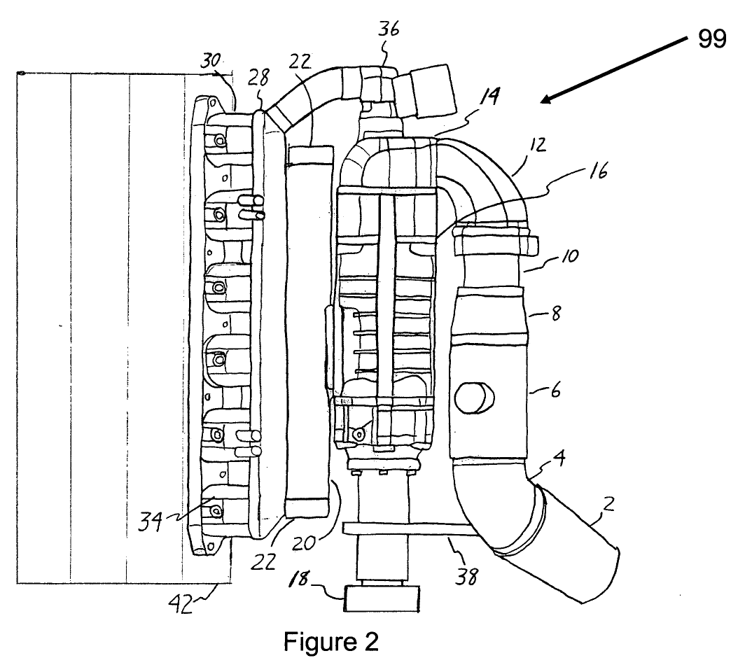

The positive displacement supercharging device (16) is located on the intake side of the inline internal combustion engine and the engine cylinder head (42), as illustrated in FIG. 2. The intake side of the inline internal combustion engine's cylinder head (42) is the side of the cylinder head (42) into which the air or air/fuel mixture enters the cylinder for combustion. Typically, the cylinder head of a modern internal combustion engine has intake and exhaust ports located on opposite sides. In the case of a longitudinally-mounted inline engine, this is typically on the left side (or driver's side in the case of US automobiles) of the inline internal combustion engine. In the case of a transverse-mounted inline engine, the location of the intake side varies from being in front of the inline engine (toward the front of the automobile) or the rear of the inline engine (toward the rear of the automobile). In the exemplary embodiments illustrated in FIGS. 1-4, the present invention provides the positive displacement supercharging device (16) on the intake side.

As indicated above, in one embodiment of the present invention, the positive displacement supercharging device (16) is a twin-screw supercharger that provides a significant supercharging affect across the entire operating speed range of the inline internal combustion engine. In other words, significant boost, i.e., about 70% or greater of maximum psi (if maximum psi is 10, then at least 7 psi), is achieved by 2000 rpm's and is maintained approximately throughout all engine speeds greater than approximately 2000 rpm's. For example, if the positive displacement supercharger device (16) has a maximum boost of 10 psi and the inline internal combustion engine has a maximum RPM limit of 8000, at least from approximately 65% to approximately 80% of the maximum boost, provided by the positive displacement supercharging apparatus (99), is typically maintained from approximately 2500 rpm's to 7800 rpm's.

The positive displacement supercharging device (16) is typically belt-driven by a non-OEM pulley (18), located at the front of the internal combustion engine, and a belt connected to a similar pulley driven by the OEM inline engine crankshaft. The belt drive is often of the multi-rib V-belt configuration used on most modern inline internal combustion engines. The belt drive will typically be in a 5 rib to 8 rib configuration. Belt lengths can vary greatly based on variables such as the existing accessory drive system on the inline engine, the placement of the positive displacement supercharging device (16), pulley sizes, and the source for power input to the positive displacement supercharging device (16).

In one exemplary embodiment, the positive displacement supercharging device (16) may be driven directly from the OEM crankshaft pulley, with the device (16) added into the existing OEM serpentine belt path with appropriate modifications. In another alternative embodiment, an additional pulley may be added to the OEM crankshaft to drive the positive displacement supercharging device (16) directly. In still yet another alternative embodiment, a pulley can be added to an OEM accessory device (not illustrated) which is driven by the crankshaft, e.g., power steering pump. The belt length required will typically range from as small as approximately 20″ in total length to approximately 90″ in total length. Thus, there are ultimately two different pulley sizes employed with the claimed positive displacement supercharger apparatus (99).

The different sizes of the two different pulleys is determined based on the total displacement of the inline internal combustion engine, the displacement or flow capacity of the positive displacement supercharging device (16), the desired operating rpm range of the inline internal combustion engine, and the desired boost or power level of the inline internal combustion engine.

As indicated above, in one embodiment, the total displacement of the inline internal combustion engine is from approximately 1.8 L to approximately 4.6 L, and is preferably from approximately 2.5 L to approximately 4.0 L. The desired operating rpm range of the inline internal combustion engine is from approximately 1 rpm to approximately 7000 rpm's for displacement sizes greater than about 4.1 L, and is preferably from 1 rpm to 8000 rpm's for displacement sizes greater than about 3.6 L, and even more preferably from 1 rpm to 9000 rpm's for displacement sizes greater than about 2.8 L.

In addition, care must be taken to ensure that the air flow capacity of the positive displacement supercharging device (16) is appropriate for the total displacement of the inline internal combustion engine, and the desired flow, boost, and power levels from the inline internal combustion engine. Typically, the crankshaft pulley diameter will range from approximately 4″ to approximately 8″, while the positive displacement supercharger device (16) pulley size will typically range from approximately 2″ diameter to approximately 4.5″ diameter. The front of the inline internal combustion engine, in the case of a longitudinally-mounted Inline engine, is located opposite to the rear of the automobile.

The ratio of the two different pulley sizes determines the operational speed of the positive displacement supercharger device (16) relative to the speed of the inline internal combustion engine. In other words, the ratio of the two different pulley sizes determines the boost or pressurization level of the inline internal combustion engine's inlet air.

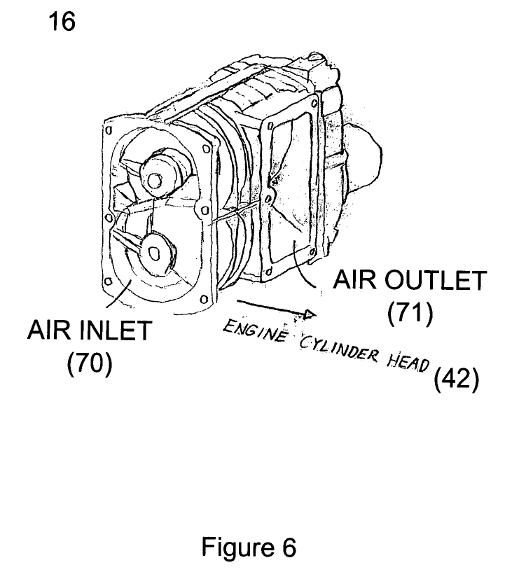

In one embodiment of the invention, which is illustrated in FIG. 6, the positive displacement supercharging device (16) comprises an air inlet (70) located at the rear of the positive displacement supercharging device (16). Specifically, the air inlet (70) is typically located nearer the firewall (passenger/driver compartment) of the automobile rather than at the front of the automobile, i.e., positioned away from the air intake apparatus (2).

As a result, air flowing from the air intake apparatus (2) of FIGS. 1-4, will ultimately enter the positive displacement supercharging device (16) through air inlet (70). In this case, the rear of the positive displacement supercharging device (16). As FIG. 6 also illustrates, the positive displacement supercharging device (16) comprises an outlet (71). Air that enters the positive displacement supercharging device (16) through air inlet (70), will exit toward the engine cylinder head (42) through air outlet (71), which is located on the side of the positive displacement supercharger device (16).

In certain applications of positive displacement supercharging devices to V-type internal combustion engines, such as Magnuson Products, Inc., the positive displacement supercharging device has been mounted to the V-type engine in “reverse”, with the positive displacement supercharging device's air inlet facing forward to the front of the automobile, i.e., away from the firewall or closer to the air intake apparatus. This type of configuration has some benefits, but seriously complicates the drive mechanism of the positive displacement supercharging device. For instance, the drive pulley on the positive displacement supercharging device becomes located toward the rear of the V-type engine, and away from the accessory drive pulley and belt system.

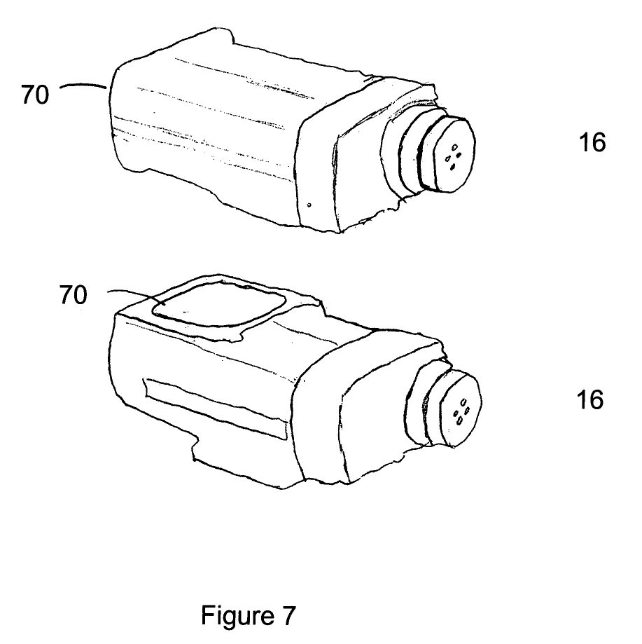

Referring now to FIG. 7, in another alternative embodiment, the air inlet (70) of the positive displacement supercharging device (16) is located at the “top” of the device (16), nearest the location of the air inlet ducting (8) and throttle valve (10) of FIGS. 1-4 (when referencing the positive displacement device as applied in the embodiment presented). In FIG. 1, the air inlet (70) illustrated in FIG. 6, is located at the rear of the positive displacement supercharging device (16) rather than at the top of the positive displacement supercharging device (16), as illustrated in FIG. 7.

One advantage of placing the air inlet (70) at the top of the positive displacement supercharging device (16) is that it reduces the amount of air inlet ducting required in the positive displacement supercharging apparatus (99), and the number of turns in the air inlet ducting, to provide the inlet air to the positive displacement supercharging device (16). As indicated above, it is preferable to have gradual turns in the air ducting and a direct path for air to flow into the positive displacement supercharging device (16). Locating the air inlet (70) on top of the positive displacement supercharging device (16) can accomplish this objective.

The disadvantage, however, of the top mounted air inlet (70), illustrated in FIG. 7, is that it can reduce the adiabatic efficiency of the positive displacement supercharging device (16). This reduction often more than negates the benefit of the reduced air inlet ducting. However, cases may exist in certain embodiments or automotive applications where the top air inlet (70) to the positive displacement supercharging device (16) may provide packaging benefits that outweigh the adiabatic efficiency compromise, and may enable the application of this invention to certain automobiles which would otherwise not be possible.

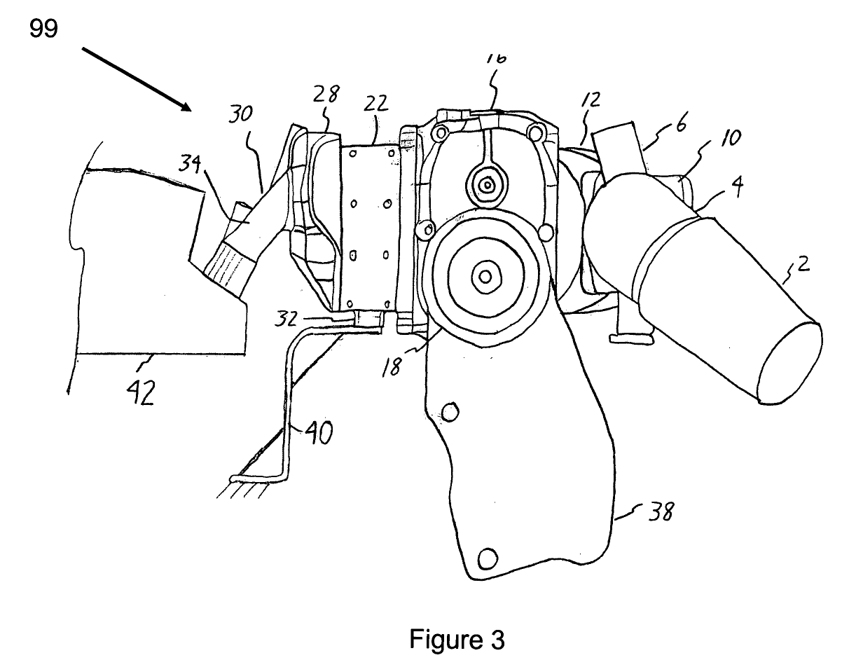

In one exemplary embodiment of the invention, the positive displacement supercharging device (16) further comprises a housing containing two counter-rotating rotors disposed about rotational axes which are oriented in a direction that is the same as the rotating axis of the associated inline internal combustion engine to which the device (16) is attached. The two axes within the positive displacement supercharger device (16) are further oriented in an essentially vertical direction with respect to each other, or in a direction which orients the positive displacement supercharger device (16) such that its outlet (71) is facing essentially towards the air inlet ports in the cylinder head (42), illustrated in FIGS. 2-3, of the inline internal combustion engine. Specifically, in the case of a longitudinally-mounted inline engine, the outlet (71) of the positive displacement device (16) is oriented toward the right side of the automobile (passenger side in the case of U.S. automobiles).

For purposes of a simplified description, the air flow is described as entering the positive displacement supercharger device (16) at the rear of the device (16), which is illustrated in FIGS. 1-4. Alternatively, and as indicated above, air flow may enter at the “top” of the device (16). In this case, that would be the side of the positive displacement supercharger device (16) which is opposite the location of the inline internal combustion engine to which the device (16) is attached. The air then flows through the positive displacement supercharger device (16) and exits at the outlet (71) of the device (16). In either disclosed embodiment, the outlet (71) of the device (16) is disposed toward the inlet ports of the cylinder head 42. The outlet (71) may direct the air flow immediately into an optional charge air cooling device (20) which is illustrated in FIGS. 1-4.

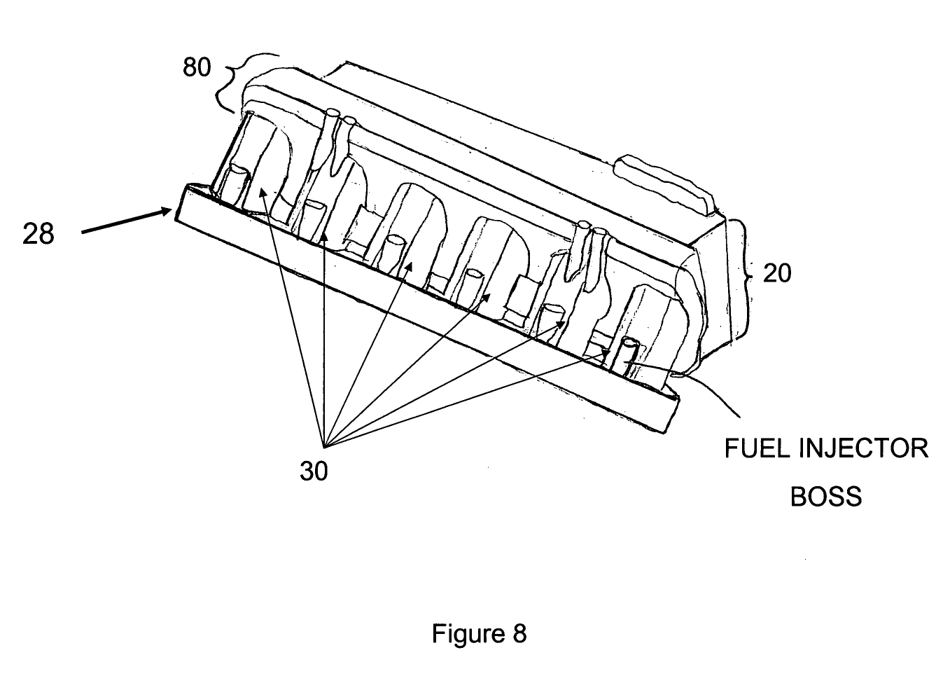

In the embodiments where a charge air cooling device (20) is present, the air flow exits the positive displacement supercharging device (16) directly into a plenum volume (80) of the non-OEM intake manifold (28). Referring now to FIG. 8, and for purposes of the present invention, the non-OEM intake manifold (28) will be described as comprising a plurality of structures: first, the optional charge air cooling device (20), if desired; second, the plenum volume (80); third, inlet runners (30); and finally, the intake manifold itself (which can be OEM or non-OEM). Although an OEM intake manifold can be used as a part of the non-OEM intake manifold (28) structure, the non-OEM intake manifold (28) structure comprises a plurality of non-OEM parts that allows the successful interaction of the positive displacement supercharging device (16) with the engine cylinder head (42). As a result, it is preferred the intake manifold itself also be a non-OEM part.

Still referring to FIG. 8, the plenum volume (80) and shape of the non-OEM intake manifold (28) must be sized appropriately to provide a substantially uniform air distribution to the individual cylinders of the inline internal combustion engine. The cross-sectional flow area of the plenum volume (80) should be approximately greater than or equal to three times the cross-section of the individual ports running to each individual cylinder of the inline internal combustion engine. This ensures uniform air flow to the various cylinders of the inline internal combustion engine with minimal losses or pulsing.

The charge air cooling device (20) is situated directly in the path of the air flow as it exits the positive displacement supercharger device (16) on its way to the engine cylinder head (42). The charge air cooling device (20) is preferably integrated into the intake manifold (28) of the inline internal combustion engine. The charge air cooling device's internal volume serves to provide, at least in some part, a portion of the intake manifold's (28) plenum volume (80).

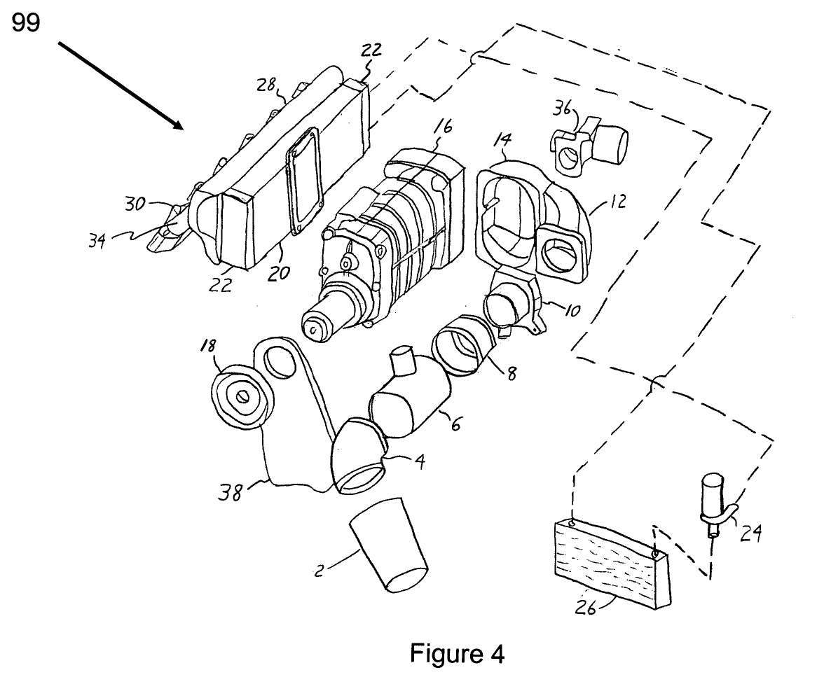

Air flow through the charge air cooling device (20) shall proceed in substantially the same direction as the air flow as it exits the positive displacement supercharger device (16) through outlet (71) to minimize airflow losses in the positive displacement supercharging apparatus (99). In one exemplary embodiment shown in FIG. 4, the charge air cooling device (20) is preferably a liquid-to-air heat exchanger. Although the charge air cooling device (20) is not required, the pressurization or compression of air is always accompanied by a significant increase in air temperature. After compression, the air is significantly denser than ambient air. The amount of air temperature increase will reduce the actual air density achieved. Charge air cooling recovers much of this lost air density.

In addition, the reduction of the charge air temperature prior to entering the combustion chamber of the inline internal combustion engine also helps to reduce the possibility of detonation (uncontrolled explosion) or pre-ignition (spontaneous combustion without it being initiated by the spark plug of the engine ignition system), both of which are detrimental to engine performance and longevity, and in many cases can result in very rapid engine failure. By reducing the inlet air temperature, the addition of pressurized air to the inline engine is safer, and the total amount of boost, airflow, and hence power output can be increased. Eliminating the charge air cooler (20) should only be considered in cases of “low boost” applications, where the boost levels would typically be maintained from approximately 3 to approximately 8 psi.

The heat exchanger (20) can be of the bar and plate type, tube and fin type, extruded finned tubular core type, or other types of compact and efficient liquid to air heat exchange devices that is well-known in the art. The charge air cooling device (20) may also comprise separate liquid manifolds for a cooling medium (22), a liquid pump and lines (24), and an external heat exchanger (26) to dissipate the heat extracted from the charge air to the atmosphere outside of the automobile, as illustrated in FIG. 4.

It should also be appreciated that the positive displacement supercharger apparatus (99) allows the use of the charge air cooling device (20). Previously, attempts were made to not only configure the positive displacement supercharging device (16) with an inline engine; but, attempts were made to use a charge air cooling device in conjunction with the positive displacement supercharger device (16). These attempts all met with failure. The disclosed positive displacement supercharger apparatus (99) provides small, efficient, and compact packaging of components to allow the use of a charge air cooling device.

In general, the air flow as it exits the positive displacement supercharger device (16) will directly enter a plenum volume (80) of the non-OEM intake manifold (28) of the inline engine. For instance, in FIG. 8, the plenum volume (80) of the non-OEM intake manifold (28) can either be an integral part of the overall intake manifold, or can be a separate mechanically attached component, which when assembled effectively becomes an integral part of the non-OEM intake manifold (28). The air first travels through the charge air cooling device (20), from which it then flows directly into the plenum volume (80) of the non-OEM intake manifold (28) of the inline engine.

From the plenum volume (80), the air flow (which will now, under appropriate conditions of power demand and engine load, is pressurized to above ambient pressure to provide the supercharging effect) will then travel in a substantially direct path to the individual cylinder distribution runners (30) of the non-OEM intake manifold (28).

The air exiting the positive displacement device (16) will typically be from approximately 3 to approximately 30 psi at full throttle opening, or full power demand of the inline engine. After the air passes through the charge air cooler (20), the air will typically lose some pressure due to the inherent flow losses in the charge air cooler (20). This should typically be in the range from approximately 0.25 psi to approximately 1 psi, but in certain applications or extremely high flow applications may exceed 2 psi but should be no greater than 4 psi. The air in the plenum volume (80) will typically, under conditions of full throttle opening or full power demand of the inline engine, range from approximately 2 psi to approximately 28 psi. Most typical daily driven applications in an automobile of this positive displacement supercharging apparatus (99) will utilize maximum boost pressures in the plenum volume (80) of the non-OEM intake manifold (28) of from approximately 5 to approximately 18 psi.

The non-OEM intake manifold (28) which may constitute a single component integrating the charge air cooler (20), the plenum volume (80), and the inlet runners or air distribution means (30), or may be an assembly of the above items which is effected by welding, adhesive bonding, or mechanical fasteners, will typically have a minimum of one cylinder distribution runner (30) per cylinder of the engine. The inlet runners (30) of FIG. 8, provide a substantially concise and direct fluid connection between the plenum volume (80) and the individual inlet ports in the engine's OEM cylinder head (42).

Typically, it is desirable to keep the inlet runners (30) substantially equal in cross-sectional area to those used in the OEM intake manifold (which is not utilized in the exemplary embodiments illustrated in FIGS. 1-4 of the positive displacement supercharger apparatus (99)). In some cases, it will be desirable to increase the cross-sectional area of the inlet runners (30) to allow for greater air flow achieved in the supercharged inline internal combustion engine. In any case, the cross-sectional area of the inlet runners (30) should not substantially exceed the cross-sectional area of the inlet ports in the inline engine's OEM cylinder head (42), otherwise air flow turbulence will result, and a loss of overall system efficiency occurs

The non-OEM intake manifold (28) also serves as the primary structural support of the positive displacement supercharger device (16). This is achieved by constructing the non-OEM intake manifold (28) from a material comprising aluminum or an aluminum alloy, or alternatively, a fiber or particulate reinforced high temperature plastic. Careful consideration is given to the design and construction of the non-OEM intake manifold (28), such that the structural load paths and wall thicknesses are adequate to support the weight and dynamic loading of the positive displacement supercharging device (16).

The design and structural quality of the non-OEM intake manifold (28), given the weight and operating requirements of the positive displacement supercharging apparatus (99), will vary depending on the total displacement of the inline internal combustion engine and boost levels desired from the positive displacement supercharging device (16).

The structural support may be provided either through the direct attachment of the non-OEM intake manifold (28) to the OEM cylinder head (42) using studs and nuts, or bolts as mechanical fasteners. Typically, the attachment of the non-OEM intake manifold (28) to the cylinder head (42) will be through OEM fasteners and attachment locations. The structural support for the non-OEM intake manifold (28) may also be provided, either in whole or at least in part, through a secondary attachment and support (40) of the non-OEM intake manifold (28) to other areas of the inline engine through either integral or separate brackets or supports (40), as illustrated in FIG. 3.

The secondary attachment (40) may provide structural support through attachment to a boss or pad (32) on the non-OEM intake manifold (28), as illustrated in FIG. 3. The non-OEM intake manifold (28) and/or runners (30) that comprise at least in part the air flow distribution of the non-OEM intake manifold (28), evenly provides air to the individual cylinders of the inline internal combustion engine, and may also include a plurality of holes or inlets for attachment of fuel injection devices to provide the appropriate fuel for the inline internal combustion engine directly near the entrance to the inlet port of the inline internal combustion engine.

The non-OEM intake manifold (28) may also provide a structure for attachment of a fuel distribution rail(s), which is used to provide an appropriate fuel supply to the fuel injection devices (not illustrated). The material of construction of the non-OEM intake manifold (28) typically comprises an aluminum or aluminum alloy to provide structural integrity and support to the positive displacement supercharging device (16). Often, the aluminum or aluminum alloy comprises an investment casting, sand casting, permanent mold casting, a weldment, a machined component, or a combination of these components. Alternatively, various polymeric or composite materials may be utilized in construction of the non-OEM intake manifold (28). These alternate materials will typically require fiber or particulate reinforcement ranging from approximately 10% to approximately 50% by volume such as the glass fiber reinforced nylon (Zytel) often used in an OEM intake manifold.

Plastic materials described in the specification should also have temperature resistance such that they can be used, and will not lose strength or stiffness over an operating range from approximately −50 degrees Fahrenheit to approximately 300 degrees Fahrenheit. The sizing of the intake manifold runners or distribution means (30) has been previously described. The portion of the non-OEM intake manifold (28), either at the charge air cooler (20) inlet or the plenum volume (80) inlet, as attached to the outlet (71) of the positive displacement supercharging device (16), should be sized to allow substantially unrestricted air flow from the outlet (71) of the positive displacement device (16) to the non-OEM intake manifold (28).

The plenum volume (80) inlet should range from approximately 10 square inches to approximately 50 square inches. The plenum volume (80) inlet, to match the outlet (71) of the positive displacement supercharging device (16), will typically be substantially rectangular, and also provide the mounting and sealing surface for the positive displacement supercharging device (16). As a result, the plenum volume (80) inlet and the outlet (71) of the positive displacement supercharging device (16), should be substantially the same size and shape, and have the same characteristic air flow abilities. The positive displacement supercharging device (16) attaches to the plenum volume (80) inlet interface using mechanical fasteners such as studs and nuts, or bolts.

In typical inline engine configurations, the throttle valve(s) for the inline internal combustion engine are located in the air flow path before the OEM intake manifold or a plenum volume of the OEM intake manifold. In other engine configurations however, the throttle valves are located in close proximity to the inlet ports of the engine cylinder head. This is typically done in very high performance applications for improved throttle response, and higher maximum flow and improved volumetric efficiency.

Various newer internal combustion engine applications, in particular BMW automobiles, the throttle valve(s) are eliminated completely, in lieu of a control system which actuates the individual inlet valves in the cylinder head to control air flow and power output of the inline engine. In other inline engine configurations, which may include individual throttle valves (34) for each cylinder, or in the more general case of one or more throttle valves located between the primary intake manifold plenum volume and the engine inlet ports, there may be throttle valves remaining in the OEM location, and/or added to this location as part of the disclosed positive displacement supercharging apparatus (99) and its corresponding non-OEM intake manifold assembly (28). From the inlet runners (30) or any ductwork/runners associated with the above described throttle arrangement; the air flow will then enter the inline engine to undergo a typical combustion process.

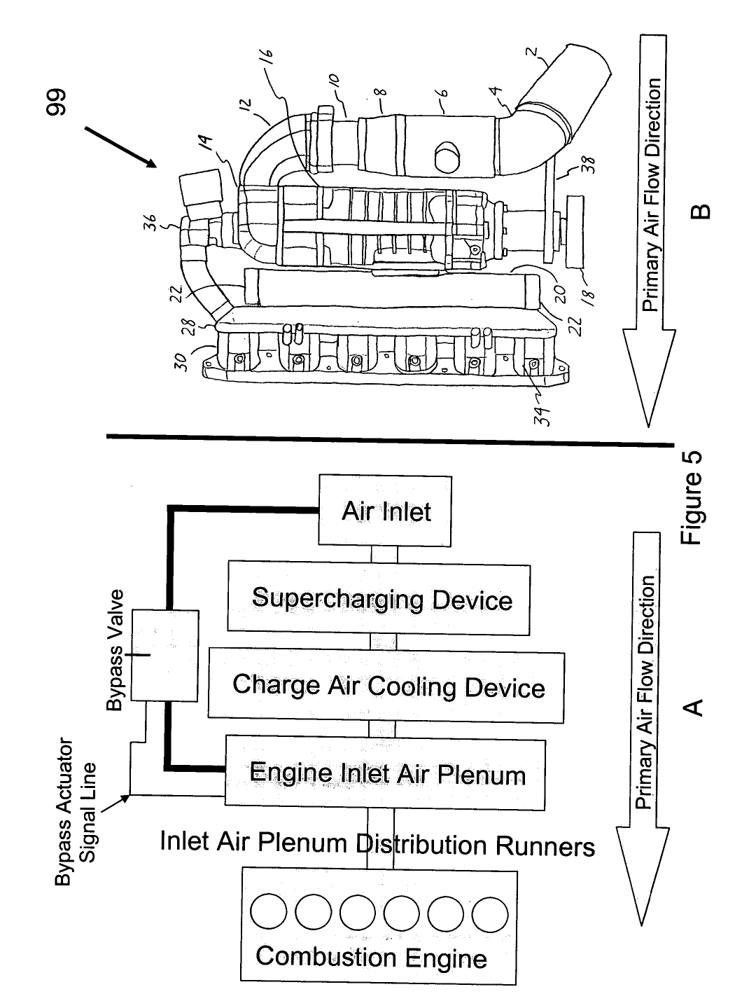

In addition, an air bypass valve (36) is situated to provide a substantially direct fluid connection between inlet duct (12) or housing (14) and either the charge air cooling device (20) or the plenum volume (80) of the non-OEM intake manifold (28). An actuator (not illustrated) for the bypass valve (36) is placed in fluid connection with the charge air cooling device (20), or the plenum volume (80) of the non-OEM intake manifold (28) to receive a manifold pressure signal (FIG. 5A).

Under conditions of low engine load or power demand (below approximately 40% throttle opening), the inline engine inlet air flow will bypass the positive displacement supercharging device (16), and also possibly the charge air cooling device (20). This provides direct air flow into the inline engine, and in the case of a positive displacement supercharging device (16) which is driven by a pulley or other connection to the inline OEM engine's crankshaft, will reduce parasitic drag on the inline engine and improve efficiency.

The provisions for air flow volume, in the air flow path through the bypass valve (36) and associated piping, should be adequate to meet the inline engine's air flow needs under all conditions where the bypass valve (36) remains open. Typically the bypass valve piping, on engine sizes ranging from 1.8 liters to 4.6 liters will range from approximately 1.0″ to approximately 2.5″ in diameter. The length of piping should be minimized as much as possible; however, total duct lengths from approximately 2″ to approximately 18″ can be used.

Some of the newer available positive displacement supercharger devices, such as the Eaton modified Roots-type superchargers, have integral bypass valves and air flow passages, requiring no external devices or ducting. Under conditions of power demand or high engine load (greater than approximately 3500 rpm's), the bypass valve shall close, directing air flow through the supercharging device, and providing pressurized air flow to the inline engine.

If required, a supplemental support (38) may also be applied to support the positive displacement supercharging device (16), preferably in the vicinity of the drive mechanism of the positive displacement supercharging device (16), which assists in supporting the drive loads imparted from the engine crankshaft to the positive displacement supercharging device (16). This supplemental support (38) may also include a plurality of holes for attachment of the inline internal combustion engine, pass through holes for engine accessory devices such as the alternator, the power steering pump, or the air conditioning system, as well as attachment points for additional idler or tensioner pulleys, as required by the drive system of the positive displacement supercharging device (16), to ensure that the multi-rib drive belt does not slip under load.

In the implementation of this invention, the positive displacement supercharging device (16) shall be located on the inlet side, i.e., intake side, of the combustion engine cylinder head (42) to ensure compact packaging and direct air flow path into the inline internal combustion engine's cylinders. The location and orientation of the components of the positive displacement supercharging apparatus (99) shall be chosen to provide the most direct air flow path achievable for the inline internal combustion engine, with short, direct flow paths, and minimal change of direction of the air flow to maximize efficiency of flow, as well as efficiency of packaging of the positive displacement supercharger apparatus (99) in an automobile inline engine compartment.

As discussed previously, providing an inlet air path with minimal restriction and turbulence is critical to the performance of a positive displacement supercharging apparatus (99), as illustrated in FIGS. 1-4, and has historically been one source of significant failures of these systems, particularly in inline 6 cylinder internal combustion engines. The configuration of the invention disclosed herein addresses those failures through the layout, relationships, and flow paths between the components in the positive displacement supercharging apparatus (99).

A method of making the supercharging apparatus is now disclosed with references to FIGS. 1-8 and as provided above to the extent necessary. For instance, the specific components that need to be fabricated and which are not included with an OEM inline engine, include, but are not limited to the air housing or inlet (14) which is typically constructed of the same materials outlined for the non-OEM intake manifold (28), the non-OEM intake manifold and charge air cooling device itself (20) either as individual components, or an integrated assembly, certain components of the inlet air ducting (4,8,12), heat exchangers, and supplemental apparatus supports (38 and 40). The method is provided in more detail set forth below and can also be referenced with the preceding paragraphs.

Referring to FIGS. 1-4, an air inlet and filtration device (2) is provided in a location that allows adequate inlet air supply for the inline internal combustion engine. The inline internal combustion engine is the OEM engine, and more preferably, is an inline internal combustion engine having a displacement of from approximately 1.8 L to approximately 4.6 L, and even more preferably a displacement of from approximately 2.5 L to approximately 4.0 L. A non-OEM part (not illustrated) can be provided as the air intake apparatus (2), if desired.

Air duct (4) is provided which is coupled to the air intake apparatus (2). The air ducting (4) should be formed from approximately 2″ to approximately 18″ in length. The air ducting (4) should be formed with an internal diameter of from approximately 2.5″ to approximately 4″. The air duct (4) should be formed of a material such as steel, aluminum, or other tubing that comprises a metal or metal alloy. Alternatively, air ducting (4) may be constructed of non-metallic materials such as plastics or composites.

Next, an air flow or air mass measurement device (6) is provided which is connected to air ducting (4). The air flow measurement device (6) should be configured to measure air flow up to from approximately 300 to approximately 1300 CFM's. The air measurement device (6) is connected to air ducting (8). Air ducting (8) is formed to be from approximately 2″ to approximately 12″ in length, and from approximately 2.5″ to approximately 4″ in diameter. In an alternative embodiment, the air ducting (8) may comprise a plurality of connections for pre-throttle air supply for an idle air bypass system, positive crankcase ventilation system, or other analogous structures.

An optional throttle valve (10) is connected to air ducting (8). The throttle valve (10) is provided to control engine power output, as well as to reduce unacceptable noise emissions from the positive displacement supercharging device (16). The optional throttle valve (10) is connected to air ducting (12). Air ducting (12) is provided with a length of from approximately 2″ to approximately 12″, and from approximately 2.5″ to approximately 4″ in diameter. Next, a housing or inlet (14) is provided that is connected to air ducting (12). This housing or inlet (14) is formed to turn and direct air flow into the rear of a positive displacement supercharging device (16) with minimal air turbulence and loss.

All turns or changes in direction of the air flow should be as gradual as possible given the packaging constraints of the automobile. As a result, the ducting provided in an automobile should comprise angles less than 90° where possible. The housing or inlet (14) serves to substantially reduce air turbulence prior to air flow that enters the positive displacement supercharging device (16). Thus, the housing or inlet (14), air ducting 12, air ducting 8, and air ducting 4 should be substantially smooth internally without any ridges or lumps therein. The air ducting (12) or housing or inlet (14) may also be formed with a plurality of additional connections for plumbing of various structures to provide a supply of engine vacuum.

Next, a positive displacement supercharging device (16) is connected to the housing or inlet (14) on the intake side of the internal combustion engine. The positive displacement device (16) is preferably a twin-screw supercharger, and even more preferably a Whipple, Lysholm, or Autorotor twin-screw supercharger. The positive displacement supercharging device (16) pressurizes the air flow received from housing or inlet (14).

The positive displacement supercharging device (16) is belt-driven by a non-OEM pulley (18) provided at the front of the internal combustion engine, and a second belt which is connected to a similar pulley driven by the OEM inline engine crankshaft. The belt drive will typically be in a 5 rib to 8 rib configuration. The positive displacement supercharging device (16) can be driven directly from the OEM crankshaft pulley. An additional pulley can also be provided to the OEM crankshaft to drive the positive displacement supercharging device (16) directly. In still yet another alternative embodiment, a pulley can be added to an OEM accessory device.

The belt length provided should be from approximately 20″ to approximately 90″ in length. The crankshaft pulley diameter will range from approximately 4″ to approximately 8″, while the positive displacement supercharger device (16) pulley size will typically range from approximately 2″ diameter to approximately 4.5″ diameter. Thus, two different pulley sizes are provided in making the disclosed positive displacement supercharger apparatus (99).

Referring now to FIG. 6, the positive displacement supercharging device (16) is provided with an air inlet (70) and air outlet (71). In one embodiment, the air inlet (70) is located at the rear (FIG. 6). In another embodiment, illustrated in FIG. 7, the air inlet (70) is located at the top rather than at the rear of the positive displacement supercharging device (16). Next, an optional charge air cooling device (20) is connected to the outlet (71) of the positive displacement supercharger device (FIGS. 1-4 and 8). A plenum volume (80) is provided and is connected to the optional charge air cooling device (20).

These elements are fastened together to integrally form a non-OEM intake manifold (28). The non-OEM intake manifold (28) is also formed with inlet runners (30) and the intake manifold itself (which can be OEM or non-OEM). The inlet runners (30) and intake manifold itself is coupled to the plenum volume (80) and/or the optional charge air cooling device (20).

The plenum volume (80) and shape of the non-OEM intake manifold (28) is formed to provide a substantially uniform air distribution to the individual cylinders of the inline internal combustion engine. The cross-sectional flow area of the plenum volume (80) should be formed approximately greater than or equal to three times the cross-section of the individual ports running to each individual cylinder of the inline internal combustion engine.

Air flow prior entering the positive displacement supercharger device (16), is not pressurized, from the plenum volume (80), the air flow (which will now, under appropriate conditions of power demand and engine load, is pressurized to above ambient pressure to provide the supercharging effect) travels in a substantially direct path to the individual cylinder distribution runners (30) of the non-OEM intake manifold (28).

The non-OEM intake manifold (28) is formed constituting a single component integrating the charge air cooler (20), the plenum volume (80), and the inlet runners or air distribution means (30). In an alternative embodiment, the non-OEM intake manifold is formed as an assembly of the above items which is affected by welding, adhesive bonding, or mechanical fasteners, will typically have a minimum of one cylinder distribution runner (30) per cylinder of the engine.

The inlet runners (30) are formed to be substantially equal in cross-sectional area to those used in the OEM intake manifold. The cross-sectional area of the inlet runners (30) should not substantially exceed the cross-sectional area of the inlet ports in the inline engine's OEM cylinder head (42), otherwise air flow turbulence will result, and a loss of overall system efficiency occurs. The non-OEM intake manifold is connected to the cylinder head.

The non-OEM intake manifold (28) is formed to serve as the primary structural support of the positive displacement supercharger device (16). Structural support is provided by directly attaching the non-OEM intake manifold (28) to the OEM cylinder head (42) using studs and nuts, or bolts as mechanical fasteners.

Structural support for the non-OEM intake manifold (28) can also be provided, either in whole or at least in part, through a secondary attachment and support (40) of the non-OEM intake manifold (28) to other areas of the inline engine through either integral or separate brackets or supports (40), as illustrated in FIG. 3. The secondary attachment (40) may provide structural support through attachment to a boss or pad (32) on the non-OEM intake manifold (28), as illustrated in FIG. 3.

The non-OEM intake manifold (28) is formed of a materially comprising an aluminum or aluminum alloy to provide structural integrity and support to the positive displacement supercharging device (16). Often, the aluminum or aluminum alloy comprises an investment casting, sand casting, permanent mold casting, a weldment, a machined component, or a combination of these components. Alternatively, various polymeric or composite materials may be utilized in construction of the non-OEM intake manifold (28). These alternate materials will typically require fiber or particulate reinforcement ranging from approximately 10% to approximately 50% by volume such as the glass fiber reinforced nylon (Zytel) often used in an OEM intake manifold.

Plastic materials described in the specification should also have temperature resistance such that they can be used, and will not lose strength or stiffness over an operating range from approximately −50 degrees Fahrenheit to approximately 300 degrees Fahrenheit.

The plenum volume (80) inlet should be formed in the range from approximately 10 square inches to approximately 50 square inches. The plenum volume (30) inlet is formed to substantially match the size and shape of the outlet (71) of the positive displacement supercharging device (16). At this point, the method of forming the positive displacement supercharger apparatus (99) is mechanically substantially complete. Additional steps regarding fuel delivery, air/fuel ratio adjustments, and other tuning aspects can then be performed.

It should also be appreciated that the method described above does not need to proceed in a linear or step-by-step fashion. For example, the non-OEM intake manifold (28) comprising the charge to air cooling device (20), plenum volume (80), and other components can be manufactured first rather than last. In short, the steps described above should be considered as non-sequential and can occur in any order desired. There are also purchased components that comprise the positive displacement supercharger apparatus (99), and additional considerations when employing the disclosed positive displacement supercharger apparatus (99), as set forth below.

Purchased components, either OEM or non-OEM that are often required, may include different air flow or air mass measurement devices (6) to accommodate the increased air flow required, larger or modified OEM or non-OEM throttling valve(s) (10, 34), different, or additional, fuel injectors to supply adequate fuel to the modified internal combustion engine, and various supplemental components such as tubing, hoses, air filtration devices, throttle cables, liquid pumps for the charge air cooling system, the positive displacement supercharging device (16) itself, etc.

As a result, the major components of the disclosed positive displacement supercharger apparatus (99), including the air housing or inlet (14), the positive displacement supercharging device (16), the optional charge air cooling device (20), the plenum volume (80) and the individual cylinder air distribution means or runners (30), along with the optional liquid manifolds (22), is assembled and leak tested outside of the automobile. The OEM vehicle intake manifold is then removed, and the above outlined assembly is installed on the OEM internal combustion engine using mechanical fasteners at the engine cylinder head, as well as by attaching any additional or supplemental structural supports using mechanical fasteners (38, 40). In addition, fuel injectors or a carburetor, air filtration device (2) ducting (4,8,12), airflow measurement device (6), optional throttling valve(s) (10,34), air bypass valve (36), optional pump and lines (24) for the charge air cooling device (20), and the drive belt can then be installed and attached.

In addition to assembly and installation of the mechanical and electrical components of the positive displacement supercharging apparatus (99), it is typically necessary to ensure that the engine management and control variables are appropriately adjusted to ensure proper operation of the inline internal combustion engine considering the addition of the added air flow or air mass provided to the inline engine.

These steps will involve ensuring that additional fuel is supplied to provide a proper air fuel ratio, as well as ensuring that the spark ignition timing is properly set for the higher cylinder pressures that will be achieved with the positive displacement supercharging apparatus (99). It should be noted that this can be affected on a carbureted engine through changing of fuel flow jetting in the carburetor.

In an electronically fuel injected engine, the use of higher flow fuel injectors, additional auxiliary fuel injectors, or higher fuel pressure is often utilized. Control of these OEM, modified OEM, or non-OEM fuel supply components, in an electronically fuel injected setup, can be achieved using modified software code, maps, and settings within the OEM fuel injection and engine management computer, and can also be affected using rising rate fuel pressure regulators that are adjusted based on the amount of boost that is being used, or can be affected by using non-OEM add-on fuel and/or fuel and timing controllers.

These non-OEM control means are sometimes referred to as “piggyback” computers, in the case of add-on controls, or as “standalone” engine management in the case of a complete replacement system. Air/fuel ratio's typically must be maintained at approximately 14.7:1 during normal engine operation where emissions controls are required to operate, and between from approximately 10:1 to approximately 13:1 during wide open throttle operation that falls outside of normal factory emissions operating range.

Ignition timing must also be controlled, and the amount of timing “advance” used in the inline internal combustion engine must often be reduced with the addition of positive manifold pressure (boost) to the inline internal combustion engine. This can be affected through adjustment of ignition distributor and vacuum or weight advance curves in the distributor in the case of older engines, or through the use of the OEM engine management system, or piggyback or standalone engine management systems in the case of more modern computer controlled engines.

In some modern engines which utilize variable camshaft or valve timing, or variable valve lift, these variables may also be altered using the above mentioned methods to enhance the performance, fuel economy, or overall efficiency of the internal combustion engine with the positive displacement supercharging apparatus (99) in place. In some cases, it is desirable to manipulate the variable valve timing and/or lift in a manner to reduce boost pressure, or cylinder pressure near the torque peak of the engine. This may be done to reduce the likelihood of detonation or pre-ignition of the air-fuel mixture in the combustion chamber as discussed previously. This can allow higher boost pressures to be run than would otherwise be possible on a given internal combustion engine, without risk of engine damage or destruction.

Various embodiments of the invention may also further comprise: 1) an air-to-liquid heat exchanger used for air cooling; 2) application of the positive displacement supercharger apparatus (99) to an internal combustion engine which utilizes variable valve timing, including specific tuning of the variable valve timing system to enhance and broaden the power curve of the internal combustion engine; 3) application of the positive displacement supercharger apparatus (99) to an internal combustion engine which does not have a conventional throttle valve for power regulation of the internal combustion engine; 4) application of the positive displacement supercharger apparatus (99) to an internal combustion engine which does have individual throttle valves for each individual cylinder, in proximity to the inlet port located in the cylinder head of the internal combustion engine; 5) application of the positive displacement supercharger apparatus to an internal combustion engine employing the Miller Cycle; and 6) application of the positive displacement supercharger apparatus (99) to an internal combustion engine where the air pressurization is achieved by using a twin-screw or Lysholm type screw compressor as the positive displacement supercharger apparatus.

The Miller cycle allows high boost pressures in conjunction with high static compression ratio of the engine. The combination typically results in detonation or pre-ignition, however in the case of the Miller cycle, the intake valve closing event is delayed to result in reduced cylinder pressures prior to ignition of the air-fuel mixture. This reduces the propensity for detonation, allows for a combination of high boost pressure and high static compression ratio to be maintained, and maintains the high expansion ratio of the engine (similar to the high static compression ratio) resulting in a highly efficient overall internal combustion engine.

The process, method of making, and disclosed positive displacement supercharger apparatus described above, illustrate preferred methods and typical apparatuses of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

What is claimed as new and desired to be protected by Letters Patent of the United States is:

1. An inline internal combustion engine coupled to a positive displacement supercharging apparatus, comprising:
a positive displacement supercharger device having an air inlet located at the rear of the inline internal combustion engine and an air outlet located at a side of the positive displacement supercharger device situated near at least one inlet port of an engine cylinder head;
a non-OEM intake manifold connected to the positive displacement supercharger device, wherein said non-OEM intake manifold structurally supports at least in part the positive displacement supercharger device; and
an inline engine connected to said positive displacement supercharger device and non-OEM intake manifold.

2. The engine as recited in claim 1, wherein said positive displacement supercharger apparatus is a twin-screw supercharger.

3. The engine as recited in claim 1, wherein said inline engine is an inline 6 cylinder engine.

4. The engine as recited in claim 1, wherein said inline engine has a displacement of from approximately 1.8 L to approximately 4.6 L.

5. The engine as recited in claim 1, further comprising a charge air cooling device.

6. The engine as recited in claim 5, wherein said charge air cooling device structurally supports at least in part the positive displacement supercharger device along with said non-OEM intake manifold.

7. The engine as recited in claim 1, wherein said non-OEM intake manifold further comprises a plenum volume and inlet runners which are integrally formed as part of the non-OEM intake manifold.

8. The engine as recited in claim 1, wherein said non-OEM intake manifold further comprises a plenum volume and inlet runners which are integrally connected to the non-OEM intake manifold.

9. A positive displacement supercharging apparatus, comprising:
a positive displacement supercharger device connected to an inline engine on the intake side of said inline engine;
a non-OEM intake manifold connected to the positive displacement supercharger device and the inline engine, wherein said non-OEM intake manifold is formed on the intake side of said inline engine; and
air ducting that provides air flow to a rear inlet of said positive displacement supercharger device.

10. The apparatus as recited in claim 9, wherein said positive displacement supercharger device is a twin-screw supercharger device.

11. The apparatus as recited in claim 9, wherein said inline engine is an inline 6 cylinder engine.

12. The apparatus as recited in claim 9, further comprising a charge air cooling device positioned between said inline engine and said positive displacement supercharger device.

13. The apparatus as recited in claim 12, wherein said charge air cooling device structurally supports at least in part the positive displacement supercharger device in conjunction with said non-OEM intake manifold.

14. The apparatus as recited in claim 9, wherein said non-OEM intake manifold further comprises a plenum volume and inlet runners which are integrally formed as part of the non-OEM intake manifold.

15. A method of forming a positive displacement supercharging apparatus, said method comprising the steps of:
providing an engine cylinder head;
connecting a positive displacement supercharger device to an intake side of the engine cylinder head;
forming a non-OEM intake manifold between the positive displacement supercharger device and the engine cylinder head;
forming a plurality of air ducts connecting said positive displacement supercharger device with an air intake apparatus, wherein air flow from said air intake apparatus enters the positive displacement supercharger device at an inlet in an ambient pressurized state, and exits the positive displacement supercharger device at a pressurized state into said non-OEM intake manifold.

16. The method recited in claim 15, wherein said step of forming the non-OEM intake manifold further comprises forming the non-OEM intake manifold with a plenum volume and inlet runners integrally connected with each other.

17. The method recited in claim 15, wherein said non-OEM intake manifold structurally supports at least in part said positive displacement supercharging device.

18. The method recited in claim 15, further comprising providing a charge air cooling device.

19. The method recited in claim 18, wherein said step of providing a charge air cooling device includes providing the charge air cooling device between said non-OEM intake manifold and said positive displacement supercharger device.

20. The method recited in claim 15, wherein said step of forming a plurality of air ducts includes forming the plurality of air ducts to have air flow enter the rear of the positive displacement supercharger device.
